(19) United States
(12) Patent Application Publication
(10) Pub. No.: US 2008/0024736 A1
(43) Pub. Date: Jan. 31, 2008

(54) Shell structure

(75) Inventors: Hung-Pin Wu, Taipei (TW); Wen-Chung Ho, Taoyuan City (TW)

Correspondence Address: LADAS & PARRY, 26 WEST 61ST STREET, NEW YORK, NY, 10023, US

(73) Assignee: BENQ CORPORATION

(21) Appl. No.: 11/825,635

(22) Filed: Jul. 6, 2007

(30) Foreign Application Priority Data
Jul. 28, 2006 (TW) 95127893

(51) Int. Cl. G02B 7/20; G03B 21/14

(52) U.S. Cl. 353/97; 359/611

(57) ABSTRACT

A shell structure is for containing one of a plurality of optic-lenses with different assembling positions to respectively assemble different kinds of optic equipments. The shell structure comprises an optic-lenses assembling frame and a containing shell provided with an assembling hole. The optic-lenses assembling frame is vertically assembled into the assembling hole and comprises a frame body provided with a frame center axis and a perforating hole formed within the frame body for the optic-lens perforating through. The perforating hole provides a hole center axis deviating from the frame center axis, so that the perforating hole can rotate to different positions to be adapted for the optic-lenses with different assembling positions perforating through when the frame body rotates around the frame center axis corresponding to the assembling hole.

### FIELD OF THE INVENTION

The present invention relates to a shell structure, and more particularly to a shell structure applied for containing one of a plurality of optic-lenses with different assembling positions to respectively assemble one of different kinds of optic devices.

### BACKGROUND OF THE INVENTION

For prior optical devices, they are usually necessary to be assembled with different optic-mechanism modules for catching different images. Generally speaking, a far distance module is equipped for catching images from or projecting images to a far position to increase the definition of images. Similarly, a close distance module is assembled for catching images from or projecting images to a close position to increase the definition of images.

Besides, no matter the processes of progressing images shooting or projecting at a far or close position, it is necessary for getting the most suitable focus to catch the image in the form of the highest definition by lengthening or shortening the length of an optic-lens within an optic-mechanism module. Thus, such optic device is usually formed with an assembling hole on a shell thereof for containing the optic-mechanism module, and assembled an optic-lens assembling frame for the lenses of the optic-mechanism module perforating through to improve the stability when lengthening or shortening the length of the lens.

Due to that the categories of optic devices are too numerous, such as video cameras, cameras, microscopes, telescopes, projectors, etc., so that the detail description of a typical structure of a prior projector is provided for representing the optic devices as mentioned. Please refer to FIG. 1, which is a structural view presenting a projector with an optic-mechanism module and a shell structure of prior arts. As shown in FIG. 1, a projector 100 includes an optic-mechanism module 1 and a shell structure 2. The optic-mechanism module 1 includes an optic-mechanism module body 11, and an optic-lens 12 being capable of lengthening and shortening from the optic—mechanism module 11. The shell structure 2 includes a containing shell 21 and an optic-lens assembling frame 22, wherein the containing shell 21 includes a front shell 211, a bottom 212, and other shells, not shown in FIG. 1, thus the containing shell 21 and the optic-lens assembling frame 22 are accommodated in the optic-mechanism module 1.

An assembling hole 211a is formed on a front shell 211 corresponding to the optic-lens 12, so that the optic-lens assembling frame 22 can be assembled and connected to the front shell 211. The optic-lens assembling frame 22 includes a perforating hole 221, and the optic-lens assembling frame 22 is usually made of rubber or other materials with well vibration-absorbing performance. The optic-lens 12 is lengthened and shortened to perforate the perforating hole 221 of the optic-lens assembling frame 22 according to the use conditions of turning on, turning off, and focus alignment, so that it is able to improve the stability during the operation periods of lengthening and shortening the optic-lens 12, cover the clearance between the assembling hole 211a and the lens 12 to avoid light interfere to the projecting images within the optic-mechanism module 1.

However, the optic-mechanism module 1 may have many different specifications due to different functions and manufacturers in practice; hence the optic-lenses 12 of different optic-mechanism module may be located at different positions corresponding to the front shell 211. For overcoming the difficulty during the processes of assembling the projector 100, there are two general solutions. The first solution is to manufacture different dies for different front shells 211 respectively fit for different optic-lenses 12 with different assembling positions. The second solution is to enlarge the dimensions of the assembling hole 211a and remove the optic-lens assembling frame 22 to make the possibility of different optic-lenses 12 with different assembling positions be directly assembled into the assembling hole 211a without considering the clearance between the optic-lenses 12 and the assembling hole 211a.

### SUMMARY OF THE INVENTION

The problems intended being solved in the present invention and the objectives of the present invention:
Form the two solutions as mentioned in the background of the invention, the first solution must manufacture different dies to manufacture the different specifications of the front shells, so the cost of manufacturing and classified-assembling may be highly increased. For the second solution, it is neither losing nice stability during the operation periods of lengthening and shortening the lenses due to losing the well support provided by the optic-lens assembling frame nor making light within the optic-mechanism leak out from the clearance between the lenses and the assembling hole to interfere the projecting images in order to affect the quality of displayed images.

Thus, the primary objective of the present invention provides a shell structure, which comprises an optic-lens assembling frame with a perforating hole capable of fitting for optic-lenses with different assembling positions, so that the optic-lenses still can get stable support and keep unnecessary light within the optic-mechanism module without additionally manufacturing other dies of a front shell.

Means of the present invention for solving problems:
For solving the problems in prior arts, the shell structure is provided in accordance with the present invention for containing one of a plurality of optic-mechanism modules and their lenses with different assembling positions to assemble one of a plurality of optic devices. The shell structure comprises an optic-lens assembling frame and a containing shell provided with an assembling hole. The optic-lens assembling frame is vortically assembled into the assembling hole, and comprises a frame body with a frame center axis and a perforating hole and formed within the frame body, wherein the perforating hole has a hole center axis deviating from the frame center axis. The perforating hole can be rotated to different positions for the lenses with different assembling positions perforating through when the frame body rotates around the assembling hole. Thus, the shell structure is able to contain different kinds of optic-mechanism modules and their optic-lenses with different assembling positions.

Effects of the present invention corresponding to prior arts:
Corresponding to the prior arts, the shell structure provided in the present invention can make the optic-lenses get stable support and no light interference within the optic-mechanism module without additionally manufacturing other dies of the front shell, so that it can save the cost of manufacturing the shell structure, and further save the cost of assembling the optic devices. Meanwhile, it can solve the interference problem of images caused by unnecessary light leaking out of the optic-mechanism module.

The devices, characteristics and the preferred embodiment of this invention are described with relative figures as follows.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a structural view presenting a projector with an optic-mechanism module and a shell structure provided by prior arts;

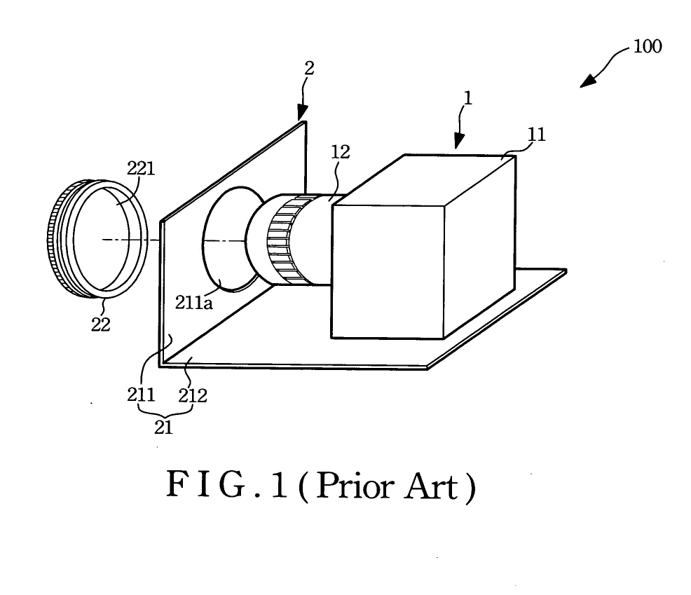

FIG. 2 is a partial exploded view presenting a preferred embodiment of the present invention;

FIG. 3 is an internal structural view presenting the preferred embodiment of the present invention applied in a high-position optic-lens;

FIG. 4 is a sectional view viewing from A-A section of FIG. 3;

FIG. 5 is a front view of an optic-lens assembling frame in FIG. 3;

FIG. 6 is an internal structural view presenting the preferred embodiment of the present invention applied in a low-position optic-lens;

FIG. 7 is a sectional view viewing from B-B section of FIG. 6; and

FIG. 8 is a front view of an optic-lens assembling frame in FIG. 6.

### DETAILED DESCRIPTION OF THE PREFERRED EMBODIMENTS

Due to that the shell structure for containing numerous kinds of lenses within optic-mechanism modules provided in the present invention can be widely applied to numerous kinds of optic devices, the combined applications are also too numerous to be enumerated and described so as to disclose a preferred embodiment in an application of projector assembling technologies for representation, hence a projector directly represents the optic devices as mentioned in the following description.

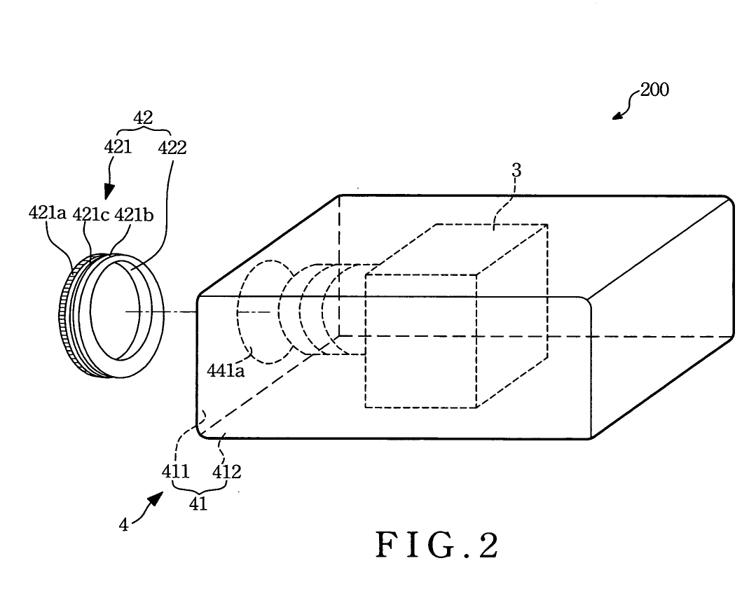

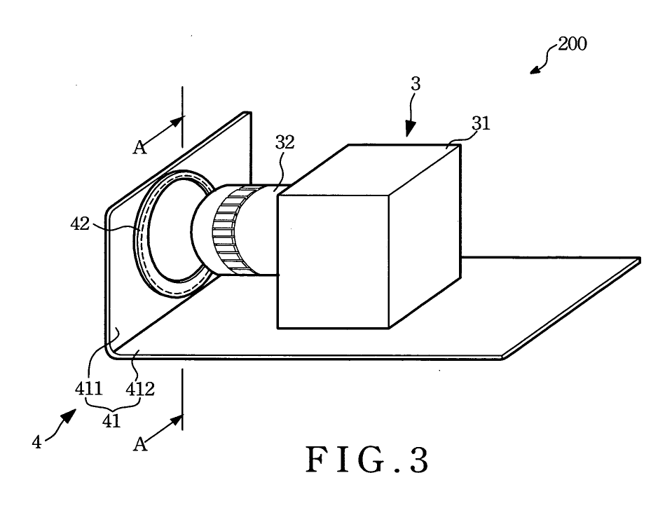

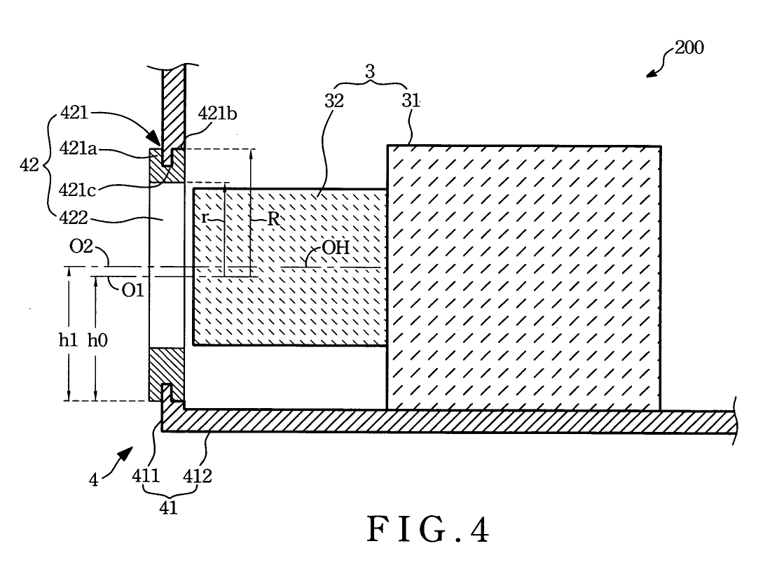

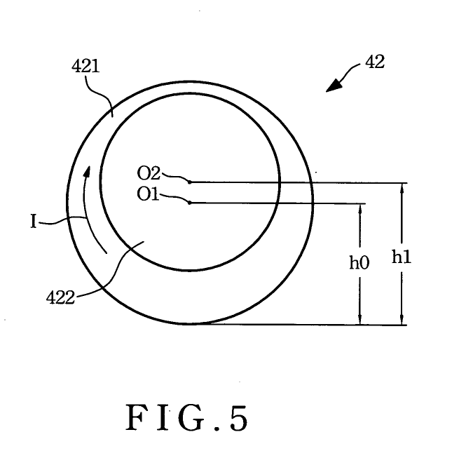

Please refer to FIG. 2 to FIG. 5, wherein FIG. 2 is a partial exploded view presenting a preferred embodiment of the present invention, FIG. 3 is an internal structural view presenting the preferred embodiment of the present invention applied in a high-position optic-lens, FIG. 4 is a schematic view presenting an A-A section in FIG. 3, and FIG. 5 is a front view of an optic-lenses assembling frame in FIG. 3. As shown in the figures, a projector 200 includes an optic-mechanism module 3 and a shell structure 4 for containing the optic-mechanism module 3.

The optic-mechanism module 3 includes an optic-mechanism module body 31 and a high-position optic-lens 32 with a high-position canter axis OH, wherein the high-position optic-lens 32 is extendable and retractable from the optic-mechanism module body 31. The shell structure 4 includes a containing shell 41 and an optic-lens assembling frame 42, wherein the containing shell 41 includes a front shell 411, a bottom shell 412, and a plurality of shells as shown in FIG. 2 without marking with element numbers. The shell structure 4 is for containing the optic-mechanism module 3 and the optic-lens assembling frame 42.

The front shell 411 of the containing shell 41 is formed with an assembling hole 411a for the optic-lens assembling frame 42 being vortically assembled in. The optic-lens assembling frame 42 includes a frame body 421 and a perforating hole 422, wherein the frame body 421 includes an outer extruded ring 421a, an inner extruded ring 421b, and a connection ring 421c, and has a frame center axis O1. A distance called frame body height deviation h0 is between the frame center axis O1 and the bottom of the frame body 421, a distance called high-position height deviation h1 is between the high-position center axis OH and the bottom of the frame body 421, and the high-position height deviation h1 is greater than the frame body height deviation h0.

The outer extruded ring 421a is located out of the front shell 411 of the containing shell 41, and has an outer diameter, defined as an extruded ring outer diameter R, greater than an inner diameter, defined as an assembling hole diameter r, of the assembling hole 411a. The inner extruded ring 421b is located within the front shell 411 of the containing shell 41, and has another outer diameter equal to the extruded ring outer diameter R and greater than the assembling hole diameter r. The connection ring 421c is connected to the outer extruded ring 421a and the inner extruded ring 421c and vortically assembled into the assembling hole 411a, so that the optic-lens assembling frame 42 can be stably and vortically assembled into the assembling hole 411a. The frame body 421 has a perforating hole 422 located therein, and the perforating hole 422 defines a hole center axis O2 deviating from the frame center axis O1 as shown in FIG. 4 and FIG. 5.

When assembling the projector 200, the optic-lens assembling frame 42 should be rotated along a rotation direction I and around the rotation center of the frame center axis O1, meanwhile, the hole center axis O2 of the perforating hole 422 also rotates corresponding to the frame center axis O1 to make the hole center axis O2 rotate to a position respect to the high-position center axis OH as shown in FIG. 4, then let the high-position optic-lens 32 extracted from the optic-mechanism module body 31 be perforated into the perforating hole 422, hereafter the shell structure 4 can contain the optic-mechanism module 3 to complete the assembling operation of the projector 200.

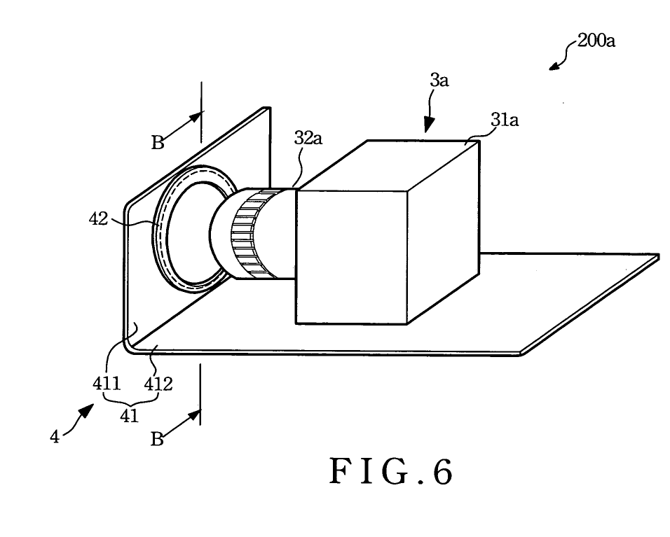

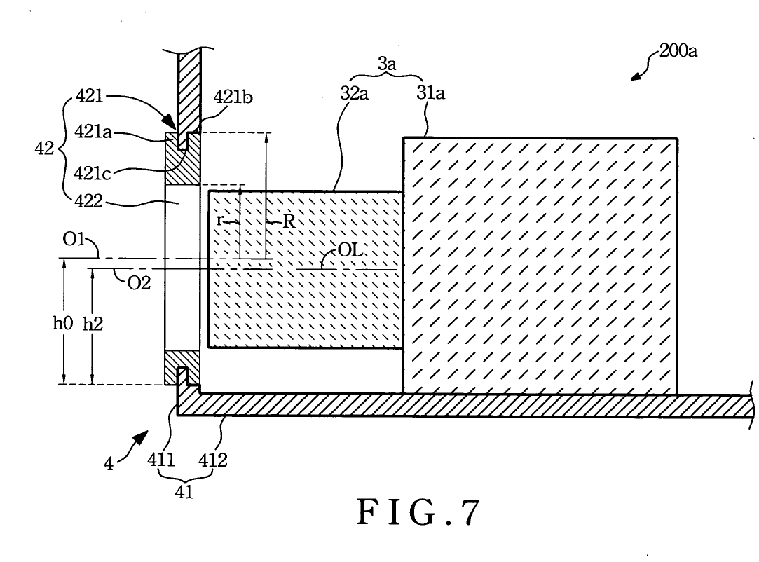

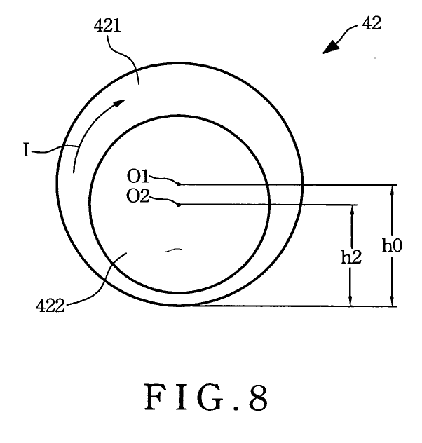

With reference to FIG. 6 to FIG. 8, FIG. 6 is an internal structural view presenting the preferred embodiment of the present invention applied in a low-position optic-lens, FIG. 7 is a sectional view viewing from a B-B section of FIG. 6, and FIG. 8 is a front view of the optic-lens assembling frame in FIG. 6. As shown in the figures, the difference between FIG. 3 to FIG. 5 and the figures is that the shell structure 4 also can be applied for continuously containing another optic-mechanism module 3a to assemble another projector 200a.

The optic-mechanism module 3a includes an optic-mechanism module body 31a and a low-position optic-lens 32a with a low-position canter axis OL, wherein the low-position optic-lens 32a is extendable and retractable from the optic-mechanism module body 31a. A distance called frame body height deviation is between the frame center axis and the bottom of the frame body 421, a distance called low-position height deviation is between the low-position center axis and the bottom of the frame body 421, and the low-position height deviation h2 is less than the frame body height deviation hO.

When assembling the projector 200a, the optic-lens assembling frame 42 should be rotated along the rotation direction I and around the rotation center of the frame center axis O1. Simultaneously, the hole center axis O2 of the perforating hole 422 also rotates corresponding to the frame center axis O1 to make the hole center axis O2 rotate to a position corresponding to the low-position center axis OL as shown in FIG. 7, then let the low-position optic-lens 32a extracted from the optic-mechanism module body 31a be perforated into the perforating hole 422, hereafter the shell structure 4 can contain the optic-mechanism module 3a to complete the assembling operation of the projector 200a.

In practice, due to that it is necessary to rotate the optic-lens assembling frame 42 to adjust the position of the perforating hole 422 when the shell structure 4 contains the optic-mechanism modules 3 and 3a, the peripheral of the outer extruded ring 421a can be pressed with rough patterns, so that users can clip the outer extruded ring 421a to conveniently rotate the optic-lens assembling frame 42. Meanwhile, the high-position optic-lens 32 is fit for a first digital micromirror device (DMD), the low-position optic-lens 32a is fit for a second DMD different from the first DMD in dimensions.

Besides, the low-position optic-lens 32a as mentioned above usually can be a lens of SVGA optic-mechanism module specified in a computer analysis standard specification provided by Video Electronics Standards Association (VESA), the high-position optic-lens 32 usually can be another lens of XGA optic-mechanism module specified in the computer analysis standard specification provided by VESA, the address of VESA is 860 Hillview Ct. Suite 150 Milpitas, Calif. 95035, the telephone number of VESA is 408-957-9270, and the fax number of VESA is 480-957-9277.

After going through above description, people skilled in the field of assembling optical device technology can easily realize that the perforating hole 422 provided for the optic-lenses, such as the high-position optic-lens 32 and the low-position optic-lens 32a as disclosed in the present invention, perforating through is able to be adjusted to different positions for different optic-mechanism modules by the means of the present invention. Therefore, the present invention can provide stable support to the lenses, either the high-position lens 32 or the low-position lens 32a. Hence, the manufacturing cost of the shell structure 4 and the assembling cost of the projector 200 or 200a are saved, and there is no need to manufacture additional dies for the front shell 411. By the way, it can also solve the light interference problem of images caused by unnecessary light leaking out of the optic-mechanism module.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A shell structure for containing one of a plurality of optic-lenses with different assembling positions, and comprising:
a containing shell provided with an assembling hole; and
an optic-lens assembling frame vertically assembled into the assembling hole, and comprising:
a frame body with a frame center axis; and
a perforating hole with a hole center axis deviating from the frame center axis formed within the frame body for the optic-lenses perforating through;
wherein the perforating hole rotates to a plurality of different positions corresponding to the frame center axis when the frame body rotates around the assembling hole, so that the perforating hole is to let the plurality of optic-lenses go through.

2. The shell structure as claimed in claim 1, wherein the optic-lens assembling frame comprises:
an outer extruded ring, which is located out of the containing shell and provided with the outer diameter greater than the inner diameter of the assembling hole;
an inner extruded ring, which is located within the containing shell and provided with the other outer diameter greater than the inner diameter of the assembling hole; and
a connection ring connected to the outer extruded ring and the inner extruded ring, and perforated into the assembling hole to be vertically assembled into the assembling hole.

3. The shell structure as claimed in claim 1, wherein the plurality of the optic-lenses with different assembling positions comprises a high-position optic-lens provided with a high-position center axis, and the perforating hole is provided for the high-position optic-lens perforating through when the perforating hole rotates corresponding to the frame center axis to make the hole center axis rotate to a position respecting the high-position center axis.

4. The shell structure as claimed in claim 3, wherein a distance called frame body height deviation is between the frame center axis and the bottom of the frame body, a distance called high-position height deviation is between the high-position center axis and the bottom of the frame body, and the high-position height deviation is greater than the frame body height deviation.

5. The shell structure as claimed in claim 3, wherein the plurality of the optic-lenses with different assembling positions comprises a low-position optic-lens provided with a low-position center axis, the perforating hole is provided for the low-position optic-lens perforating through when the perforating hole rotates corresponding to the frame center axis to make the hole center axis rotate to a position respecting the low-position center axis, the high-position optic-lens is fit for a first digital micromirror device (DMD), and the low-position optic-lens is fit for a second DMD different from the first DMD in a dimension specification.

6. The shell structure as claimed in claim 5, wherein the low-position optic-lens is a lens of SVGA optic-mechanism module specified in a computer analysis standard specification provided by Video Electronics Standards Association (VESA), the high-position optic-lens is another lens of XGA optic-mechanism module specified in the computer analysis standard specification provided by VESA.

7. The shell structure as claimed in claim 1, wherein the plurality of the optic-lenses with different assembling positions comprises a low-position optic-lens provided with a low-position center axis, the perforating hole is provided for the low-position optic-lens perforating through when the perforating hole rotates corresponding to the frame center axis to make the hole center axis rotate to a position respecting the low-position center axis.

8. The shell structure as claimed in claim 7, wherein a distance called frame body height deviation is between the frame center axis and the bottom of the frame body, a distance called high-position height deviation is between the low-position center axis and the bottom of the frame body, and the low-position height deviation is less than the frame body height deviation.

9. A projector comprising:
an optic-mechanism connected to one of a plurality of optic-lenses with different assembling positions;
a containing shell provided with an assembling hole; and
an optic-lens assembling frame vortically assembled into the assembling hole, and comprising:
a frame body with a frame center axis; and
a perforating hole forming within the frame body for the optic-lenses perforating through and provided with a hole center axis deviating from the frame center axis;
wherein the perforating hole rotates to a plurality of different positions corresponding to the frame center axis when the frame body rotates around the assembling hole, so that the perforating hole is to let the plurality of optic-lenses go through.

10. The projector as claimed in claim 9, wherein the optic-lens assembling frame comprises:
an outer extruded ring, which is located out of the containing shell and provided with the outer diameter greater than the inner diameter of the assembling hole;
an inner extruded ring, which is located within the containing shell and provided with the other outer diameter greater than the inner diameter of the assembling hole; and
a connection ring connected to the outer extruded ring and the inner extruded ring, and perforated into the assembling hole to be vortically assembled into the assembling hole.

11. The projector as claimed in claim 9, wherein the plurality of the optic-lenses with different assembling positions comprises a high-position optic-lens provided with a high-position center axis, and the perforating hole is provided for the high-position optic-lens perforating through when the perforating hole rotates corresponding to the frame center axis to make the hole center axis rotate to a position respecting the high-position center axis.

12. The projector as claimed in claim 11, wherein a distance called frame body height deviation is between the frame center axis and the bottom of the frame body, a distance called high-position height deviation is between the high-position center axis and the bottom of the frame body, and the high-position height deviation is greater than the frame body height deviation.

13. The projector as claimed in claim 1, wherein the plurality of the optic-lenses with different assembling positions comprises a low-position optic-lens provided with a low-position center axis, the perforating hole is provided for the low-position optic-lens perforating through when the perforating hole rotates corresponding to the frame center axis to make the hole center axis rotate to a position respecting the low-position center axis, the high-position optic-lens is fit for a first digital micromirror device (DMD), and the low-position optic-lens is fit for a second DMD different from the first DMD in a dimension specification.

14. The shell structure as claimed in claim 13, wherein the low-position optic-lens is a lens of SVGA optic-mechanism module specified in a computer analysis standard specification provided by Video Electronics Standards Association (VESA), the high-position optic-lens is another lens of XGA optic-mechanism module specified in the computer analysis standard specification provided by VESA.

15. The projector as claimed in claim 9, wherein the plurality of the optic-lenses with different assembling positions comprises a low-position optic-lens provided with a low-position center axis, the perforating hole is provided for the low-position optic-lens perforating through when the perforating hole rotates corresponding to the frame center axis to make the hole center axis rotate to a position respecting the low-position center axis.

16. The projector as claimed in claim 15, wherein a distance called frame body height deviation is between the frame center axis and the bottom of the frame body, a distance called low-position height deviation is between the low-position center axis and the bottom of the frame body, and the low-position height deviation is less than the frame body height deviation.
